(19) United States
(12) Patent Application Publication
(10) Pub. No.: US 2009/0189132 A1
(43) Pub. Date: Jul. 30, 2009

(54) Pallet Truck with Extending Forks

(75) Inventors: Hendrik Meijer, St. Jacobiparochie (NL); Folkert De Graaf, Blessum (NL)

Correspondence Address: THE WEBB LAW FIRM, P.C., 700 KOPPERS BUILDING, 436 SEVENTH AVENUE, PITTSBURGH, PA, 15219, US

(73) Assignee: GEBR. MEIJER ST. JABIK B.V., St. Jacobiparochie (NL)

(21) Appl. No.: 12/304,382

(22) PCT Filed: Jun. 15, 2007
(86) PCT No.: PCT/NL07/00150

§ 371 Date: Mar. 10, 2009

(30) Foreign Application Priority Data
Jun. 15, 2006 (NL) 1032013
Oct. 10, 2006 (NL) 1032657

(51) Int. Cl. B62B 3/06

(52) U.S. Cl. 254/2 R

(57) ABSTRACT

The invention relates to a pallet truck for substantially horizontal displacement of goods, comprising: a displaceable frame; at least one elongate fork connected to the frame for carrying the goods, wherein the fork is provided with a support wheel at a distance from the frame, and wherein the fork can be selectively extended in longitudinal direction via an extending mechanism. The invention also relates to a system for extending a carrying part of a pallet truck, comprising: at least one elongate fork connectable to a frame for carrying the goods, wherein the fork is provided with a support wheel at a distance from the frame, and wherein the fork can be selectively extended in longitudinal direction via an extending mechanism. The invention finally relates to a method for use and/or control of a pallet truck and/or system.

The invention relates to a pallet truck for substantially horizontal displacement of goods, comprising a frame and one or more forks connected to the frame for displacing these goods.

Such pallet trucks are generally known and are for instance used in shops, warehouses, factories and trucks. In a lowered position the forks of such a pallet truck are inserted under a load or engage in a pallet, whereafter the forks are moved upward in vertical direction to a raised position. The goods are then displaced in horizontal direction to the desired set-down position. At this position the forks are once again displaced vertically in downward direction in order to set down the load, whereafter the forks are moved out from under the load or are moved out of the pallet. Loads of differing dimensions are herein transported on the same pallet truck such that, in the case of a relatively small load, the forks extend beyond the load and the protruding parts can cause damage to buildings, goods and/or people. Conversely, relatively short forks in the case of a large load can result in this load sliding or falling from the fork, with possible damage as a result. Positions for unloading from for instance trucks and warehouse storage racks are moreover usually limited in space, and known pallet trucks need a relatively large amount of space to manouevre the pallet truck, both with and without load.

The invention has for its object to provide a pallet truck of this type with which the above stated problems are solved and loads can be displaced in more efficient manner.

The present invention provides a pallet truck for substantially horizontal displacement of goods, comprising a displaceable frame and at least one elongate fork connected to the frame for carrying the goods, wherein the fork is provided with a support wheel at a distance from the frame.

By extending or sliding out the forks of the pallet truck in longitudinal direction the length of these forks can be adjusted to the load for displacement, such as for instance one of the standard types of pallet. This achieves that forks do not extend unnecessarily beyond the load for displacing, and damage during manoeuvring and placing of the load is avoided. Through extending of the forks a great variety of goods, including pallets, can also be displaced in responsible manner without these goods for instance being able to slide off the forks. Owing to the extending mechanism a pallet truck can further be displaced in retracted position during displacement thereof without a load, whereby the turning circle of the pallet truck remains minimal and a relatively small space is therefore required for manoeuvring purposes. A further advantage here is that the pallet truck requires less storage space in the retracted position. It is also possible, if desired, to displace for instance two pallets simultaneously in a (partially) extended position.

In a further preferred embodiment according to the present invention the support wheel of the pallet truck is placed in or close to a free outer end of the fork in substantially any extending position of the fork.

Placing the wheel in the extending part of a fork achieves that a load can also be displaced in stable manner in an extended position of a fork such that a pallet truck which is heavily loaded on the front side of the fork cannot tip over.

In a further preferred embodiment according to the present invention the support wheel can be moved downward via a lifting mechanism.

Owing to the downward movement of the support wheel for the purpose of displacing the load, a user-friendly pallet truck is obtained which is simple to handle.

In a further preferred embodiment according to the present invention the pallet truck is further provided with a raising mechanism for moving the fork in vertical direction relative to the frame.

The raising mechanism makes it possible for the forks to be displaced in vertical direction for the purpose of displacing the load and being able to pick up and set down this same load in efficient manner. The raising mechanism can preferably be used irrespective of the position of the forks so that, for instance in the case of the forks being in an intermediate position in horizontal direction, these forks can also be moved in vertical direction. This raising mechanism can be of a mechanical type with for instance spindles, although hydraulic, pneumatic and/or electric lifting mechanisms are for instance also possible. In preference the lifting mechanism and the raising mechanism are operatively coupled. A synchronous operation of raising the forks and lowering the support wheel is hereby realized. Both mechanisms are preferably driven simultaneously so as to realize an efficient and safe use of the pallet truck. The lifting mechanism can be driven manually or electrically.

In a further preferred embodiment according to the invention the pallet truck is provided with a drive placed in or close to the frame, wherein the drive is operatively connected to the lifting mechanism via a transmission variable in length for the purpose of extending the forks. In an advantageous embodiment the transmission is embodied as a hydraulic hose placed with a loop or on a roll in the fork of the pallet truck. In a further advantageous embodiment the lifting mechanism is driven by two lifting cylinders placed in the frame of the pallet truck. A uniform driving is hereby obtained.

By providing the lifting mechanism with a drive the forks can be raised in vertical direction in a user-friendly manner both with and without load. Because the forks can be extended, the transmission is provided so as to be variable in length in order to enable this sliding in and out of the forks.

A user-friendly pallet truck is provided by driving the extending mechanism with an electric and/or hydraulic drive. In an advantageous embodiment according to the invention the extending mechanism of the pallet truck is provided with at least one hydraulic cylinder for extending the forks. The housing of a cylinder is here preferably mounted on or close to the frame. The extending part of the cylinder is mounted on the foremost part of the forks. A favourable transmission of forces is hereby obtained. The extending mechanism is preferably further provided with a so-called synchronizing system. Only one cylinder need here be driven, and other cylinders co-displace automatically, wherein the amount of oil required to slide the forks in and out is limited. A pressure-relief valve for releasing an overpressure in the cylinder and a pressure-generating valve for increasing pressure in the cylinder are preferably further provided. This achieves that all cylinders can be fully extended or fully retracted. In addition, the extending mechanism is preferably connected to a reservoir for the purpose of realizing a closed hydraulic system. The reservoir is preferably the reservoir already provided in the frame.

In a further preferred embodiment according to the present invention the drive comprises at least one hydraulic main lifting cylinder placed in or close to the frame, and the transmission comprises at least one hydraulic lifting cylinder placed in or close to the foremost part of a fork, wherein the lifting cylinder is operatively connected to the main lifting cylinder via a hydraulic transmission of variable length. In an alternative embodiment the transmission comprises a first hydraulic lifting cylinder placed in or close to the frame, wherein the lifting cylinder is operatively connected to a hydraulic main lifting cylinder placed in or close to the frame, and a second hydraulic lifting cylinder placed in or close to the foremost part of a fork, wherein the second cylinder is operatively connected to the first cylinder via a hydraulic transmission of variable length.

Extending or sliding out of the forks is made possible by the use of a flexible transmission, wherein the support wheel can co-displace with a front free outer end of the fork. The main lifting cylinder can for instance here be placed in vertical position in the frame so as to thereby minimize the dimensions of the pallet truck. The lifting mechanism is preferably also provided with one or more valves for holding the forks of the device substantially in a horizontal plane. In the extended position of the forks the valves open and realize a connection between the lifting cylinders and an oil reservoir, with which a closed system is obtained and which ensures that sufficient oil is present in the system. This achieves that, for instance in the case of oil leakage, the pallet truck does not start to lift in askew position and also that air present in the system is guided to the reservoir. The reservoir is preferably used here that is already provided in the frame. A further advantage of the extending mechanism of the stated type is that the risk of buckling of a push rod in a mechanical transmission between frame and wheel is avoided. This is realized in that long push rods and/or spindles are not necessary for the transmission due to the use of the relatively short cylinders. The lifting mechanism can also be activated irrespective of the position of the forks.

In a further preferred embodiment according to the invention the lifting cylinder is provided with a flushing system, comprising a spring and a ball placed in an opening of a piston of the lifting cylinder and a channel between a pressure side and a discharge channel of the piston which is closed in retracted position of the cylinder and opened in a fully extended position of the cylinder by moving the ball relative to the piston.

The flushing system achieves that dirt and air in the cylinder and in the hydraulic system can be discharged.

In a further preferred embodiment according to the invention the forks can be extended in the range of 800-1200 mm.

Because the forks can be extended in the above stated range, a so-called Europallet can be displaced on both the short and the long side with the pallet truck according to the present invention without a pallet either hanging over the front part of the forks or the forks protruding beyond the pallet. It is further noted that with the use of a pallet truck which can preferably also be used in an intermediate position of the extending mechanism, block pallets of 1000 mm can for instance be processed in advantageous manner. It is noted here that other ranges, including for instance up to 2400 mm, are also possible with the pallet truck according to the present invention.

The invention also relates to a system for extending a carrying part of a pallet truck according to one or more of the claims 1-15.

Owing to the system it is possible to combine an extending mechanism with a pallet truck of the known type. It hereby becomes possible in advantageous manner with existing devices to obtain a more efficient use of the pallet truck.

The invention also relates to a method for using the device according to one or more of the claims 1-16.

The invention is further elucidated in the following description with reference to the exemplary embodiments shown in the figures, in which:

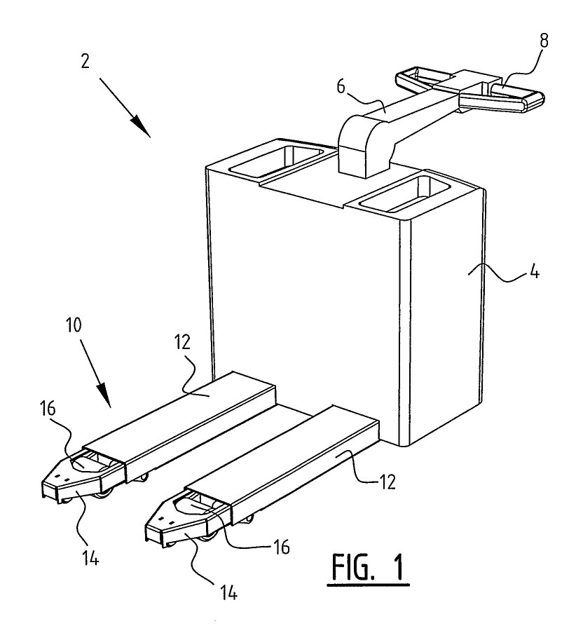

FIG. 1 shows a view of a pallet truck according to the invention:

FIG. 2 shows the pallet truck of FIG. 1 with a pallet;

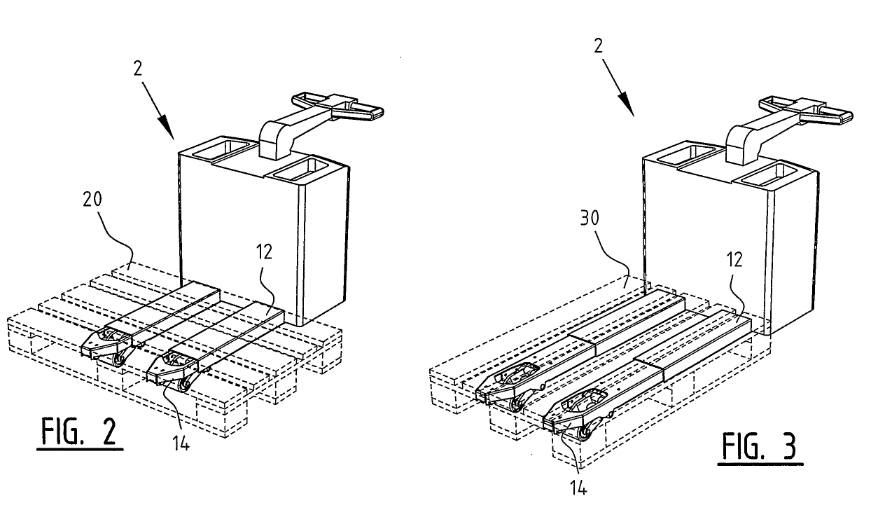

FIG. 3 shows the pallet truck of FIG. 1 with a pallet in a different orientation;

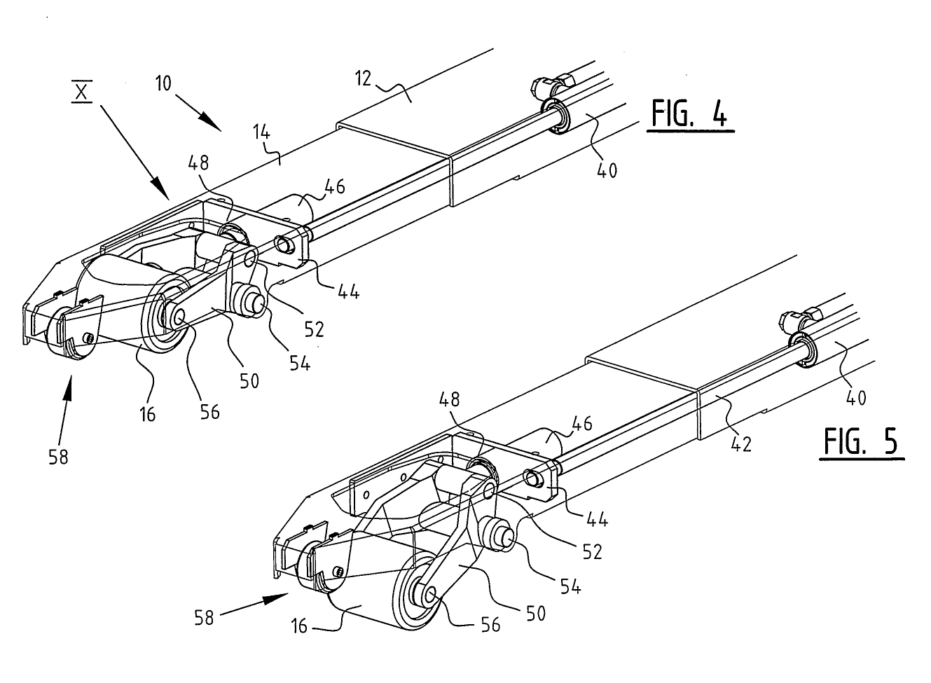

FIG. 4 shows the fork of the pallet truck according to the invention in lowered position;

FIG. 5 shows the fork of FIG. 4 in raised position;

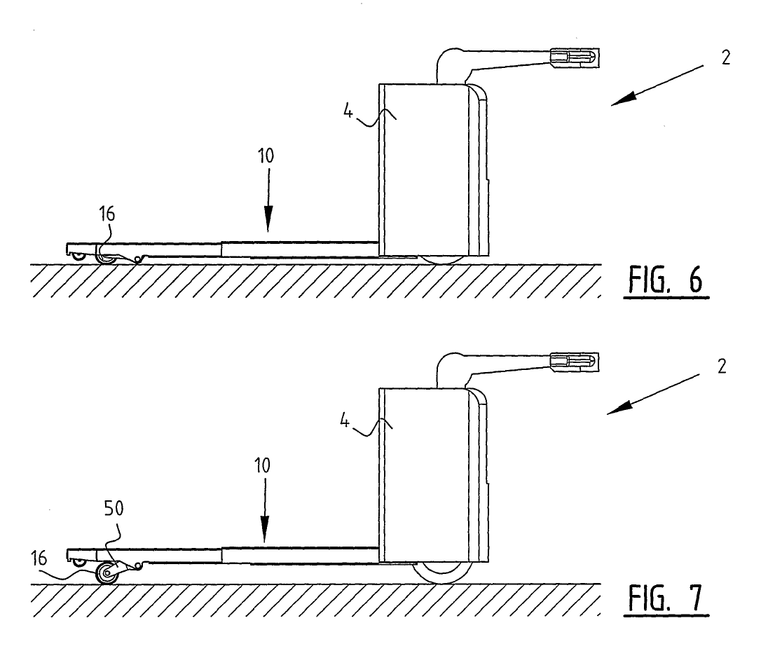

FIG. 6 shows a side view of the pallet truck according to the invention in lowered position;

FIG. 7 shows a side view of the pallet truck according to the invention in raised position;

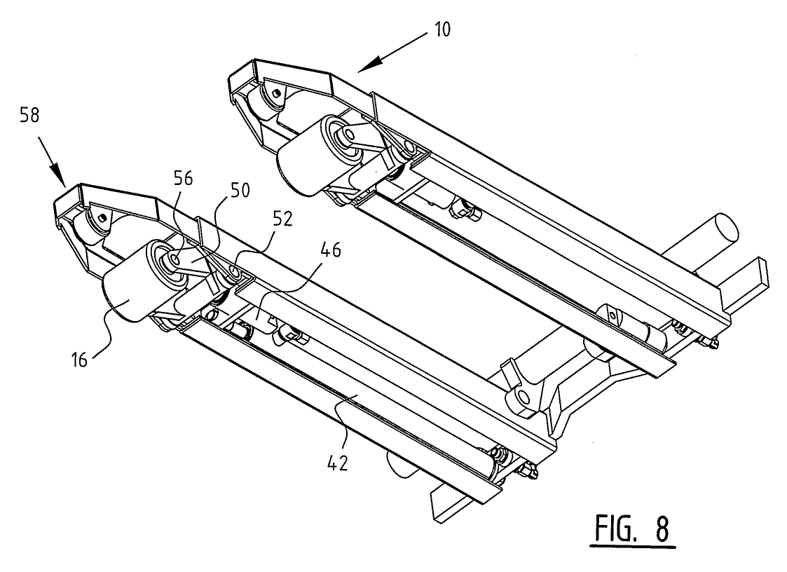

FIG. 8 shows a bottom view of the forks of the pallet truck according to the invention;

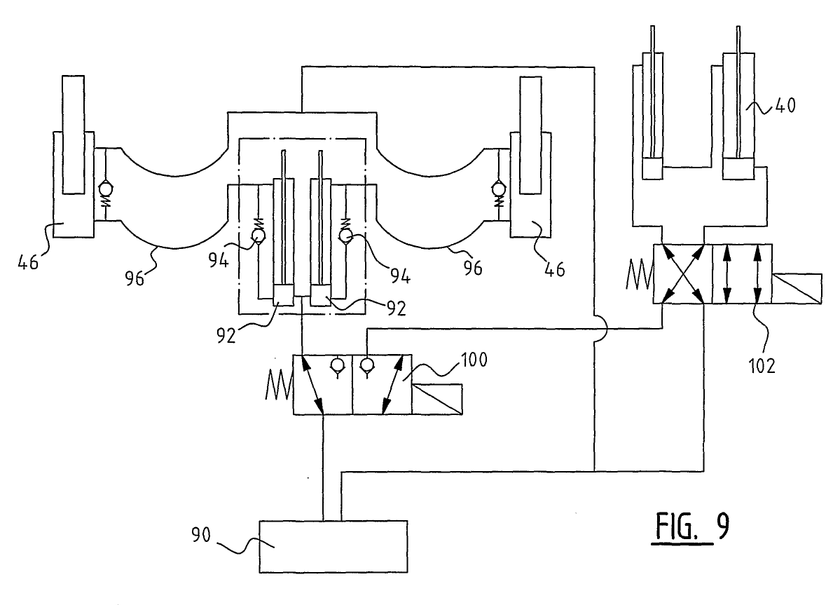

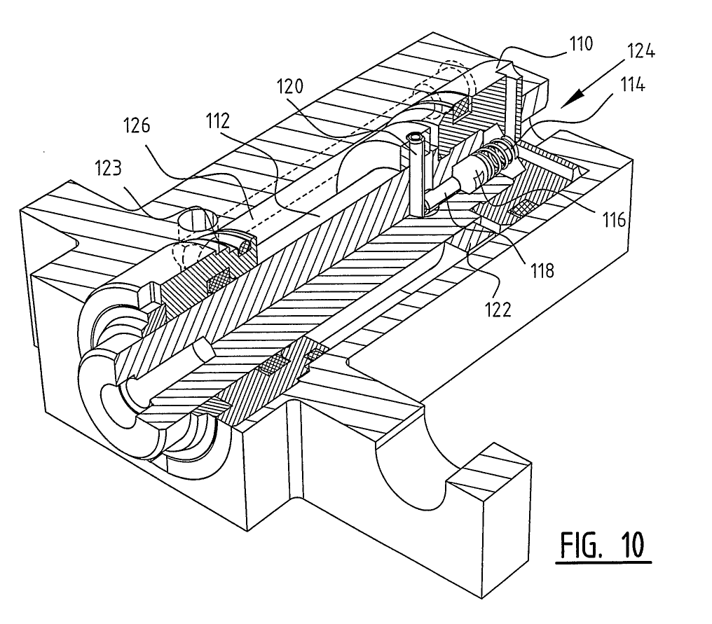

FIG. 9 shows a view of the hydraulic diagram according to the invention; and

FIG. 10 shows a view of a lifting cylinder in an outer end of the fork of a pallet truck according to the invention.

FIG. 1 shows a pallet truck 2 provided with a frame housing 4, on one side of which an arm 6 with handle 8 is attached for the purpose of displacement of pallet truck 2 by the user. The goods to be transported are placed on forks 10 which are arranged on the other side of frame housing 4 and which have a fixed part 12 which is fixedly attached to frame housing 4 and an extending part 14 which is provided with a support wheel 16 and which is mounted in extendable manner in the fixed part 12 of fork 10.

Pallet truck 2 is shown in FIG. 2 with a pallet 20 to be transported placed on forks 10 with the short side in the lengthwise direction of these forks 10. This means that the extending part 14 of forks 10 is placed in a more retracted position in the foremost part 12 of forks 10. Forks 10 hereby do not protrude beyond pallet 20. FIG. 3 shows a pallet 30 placed on forks 10 with the long side in the lengthwise direction of forks 10. The extending part 14 of forks 10 is situated in a more extended position in relation to the foremost part 12 of fork 10. The whole pallet 30 is hereby supported along the whole long side by forks 10 of pallet truck 2.

The foremost part of fork 10 is shown in FIG. 4 and 5, wherein FIG. 4 shows the forks in lowered position and FIG. 5 shows the forks in raised position. The extending part 14 of fork 10 is connected to the fixed part 12 of forks 10 for extension by means of cylinder housing 40. Cylinder housing 40 is placed in the fixed part 12 of fork 10, wherein arm 42 of the cylinder can be moved relative to cylinder housing 40 and the outer end of which is connected to a connecting support 44 placed on extending part 14 of fork 10. The foremost part 14 can hereby be extended or retracted relative to the fixed part 12 of fork 10. In already known pallet trucks the lifting force is transmitted by means of a lifting cylinder placed in frame housing 4, by means of a siphon and a pressure rod (not shown) in the fork, to a tilting support with which the support wheel 16 is moved. In the embodiment of the fork 10 according to the invention shown in FIG. 4 and 5 on the other hand, support wheel 16 is moved by means of a front lifting cylinder 46, the arm 48 of which can be extended or retracted. The driving of this front lifting cylinder 46 takes place by means of a lifting cylinder (not shown) placed in frame housing 4 and a hydraulic transmission (not shown) between these two cylinders. Arm 48 of the front lifting cylinder 46 is connected to tilting support 50 which pivots about rotation shaft 52 and tilts on tilt shaft 54. Wheel shaft 56 is moved by tilting the tilting support 50 about tilt shaft 54, whereby from a lowered position the support wheel 16 is positioned in a raised position, or in reverse direction. In the shown embodiment forks 10 of pallet truck 2 are lifted through a vertical distance of about 120 mm. The cylinders are also provided with hydraulic valves (not shown) which provide for the connection between the cylinders and an oil reservoir. Thus is achieved that sufficient oil remains in the system, the forks are raised uniformly even in the case of oil leakage, and air can flow automatically to the reservoir.

FIGS. 6 and 7 show a side view of pallet truck 2 wherein the forks are placed respectively in lowered and raised position. Tilting support 50 is clearly visible, particularly in the raised position. FIG. 8 shows a bottom view of forks 10, wherein an additional support 58 is shown on the front side of fork 10.

The hydraulic diagram of pallet truck 2 is shown schematically in FIG. 9. The components are connected here to a hydraulic system 90 of an existing pallet truck provided with a tank, pump, safety valve (not shown). Both lifting cylinders 92 in frame 4 are driven from the system. Lifting cylinders 92 are provided with a valve 94 which is opened in the extended position of the cylinders, for instance at 120 bar. Valve 94 is driven mechanically by a pin in the piston (not shown) which makes contact with the rear side of the cylinder. Oil can hereby be flushed by the pistons to the front lifting cylinders 92 in the fork which can then be flushed. The two lifting cylinders 92 are each connected by means of a hydraulic hose 96 which can be rolled up to the front lifting cylinders 46 placed in forks 10. The volumes of lifting cylinders 92 and 46 are adjusted to each other. In the shown embodiment the hydraulic subsystem with the lifting mechanisms is connected by means of a valve 100 to the hydraulic subsystem with the extending mechanism. This subsystem comprises a valve 102 and two cylinders 40, wherein by adjusting the volume of cylinders 40 and the connection between them a synchronized system is obtained whereby cylinders 40 extend and retract in almost the same manner.

Cylinder 46 is shown in more detail in FIG. 10. Shown here is a flushing system for preventing problems in the hydraulic system as a result of air or dirt. To this end the piston 110 is screwed onto a piston rod 112, wherein space is provided for a spring 114 and a ball 160. A tensioning bush 118 is also placed in longitudinal direction of piston rod 112. In transverse direction thereof a tensioning bush 120 with a diameter of for instance 4 mm is placed in an opening of for instance 8 mm. In this case a movement of 4 mm of ring 122 becomes possible relative to the piston rod. When piston 110 arrives in the extended position, steel ring 122 contacts the rear of cylinder head 123. Ring 122 hereby shifts relative to piston rod 112. Tensioning bush 118 is displaced by tensioning bush 120, whereby the ball 116 is pressed from the seating in piston rod 112. This has the result that oil and possibly air can be displaced by piston 110 to piston rod 112 and is subsequently discharged in the transverse direction through the opening. Oil and air can hereby leak from the pressure side 124 of piston 110 to the return conduit 126 and is then fed back to the reservoir (not shown). In the situation where piston 110 moves back, spring 114 pushes the ball 116 back onto the seating, whereby oil and air cannot flow from pressure side 124 of piston 110 to return conduit 126. In order to also discharge possible air in the cylinder there are, in view of the differences in density of oil and air, four channels (not shown) which are arranged for instance on the periphery of the piston and which come together in the chamber where spring 114 is placed. The air can hereby be discharged from the cylinder, irrespective of the position of the cylinder. The air can hereby also be discharged from the whole hydraulic system by placing lifting. cylinders 92 in the extended position and pumping through via pressure-relief valve 94 and subsequently discharging the air via the flushing system.

The present invention is not limited to the above described preferred embodiments thereof; the rights sought are defined by the following claims, within the scope of which many modifications can be envisaged. It is thus possible for instance to give the hydraulic transmission in the lifting mechanism for instance a mechanical form by means of a chain which can be pulled and/or telescopic arms, or by means of an electrically driven spindle. It is also possible for instance to provide a fork according to the invention which consists of three parts, the foremost two parts of which can be extended so as to thereby bring about, among other things, a greater difference between the fully retracted and fully extended position. Extending of the forks of the pallet truck can for instance be performed electronically instead of manually, whereby among other things a very precise extended length of the forks can be realized.

1-17. (canceled)

18: A pallet truck for substantially horizontal displacement of goods, comprising:
(a) a displaceable frame; and
(b) at least one elongate fork connected to the frame for carrying the goods, wherein the fork is provided with a support wheel at a distance from the frame, and wherein the fork can be selectively extended in a longitudinal direction via an extending mechanism.

19: The pallet truck as claimed in claim 18, wherein the support wheel is placed in or close to a free outer end of the fork in substantially any extending position of the fork.

20: The pallet truck as claimed in claim 18, wherein the support wheel can be moved downward via a lifting mechanism.

21: The pallet truck as claimed in claim 20, further including a raising mechanism for moving the fork in a vertical direction relative to the frame.

22: The pallet truck as claimed in claim 21, wherein the raising mechanism is operatively coupled to the lifting mechanism.

23: The pallet truck as claimed in claim 22, further including a drive placed in or close to the frame, wherein the drive is operatively connected to the lifting mechanism via a transmission variable in length for the purpose of extending the fork.

24: The pallet truck as claimed in claim 18, wherein the extending mechanism is further provided with an electric and/or hydraulic drive for the purpose of extending the fork.

25: The pallet truck as claimed in claim 24, wherein the drive comprises at least one hydraulic cylinder for extending the fork.

26: The pallet truck as claimed in claim 25, wherein the extending mechanism is further provided with:
a pressure-relief valve for releasing an overpressure in the cylinder;
a pressure-generating valve for increasing pressure in the cylinder.

27: The pallet truck as claimed in claim 24, wherein the extending mechanism is connected to a reservoir for the purpose of realizing a closed hydraulic system.

28: The pallet truck as claimed in claim 23, wherein the drive comprises at least one hydraulic main lifting cylinder placed in or close to the frame, and the transmission comprises at least one hydraulic lifting cylinder placed in or close to the foremost part of a fork, and wherein the lifting cylinder is operatively connected to the main lifting cylinder via a hydraulic transmission of variable length.

29: The pallet truck as claimed in claim 28, wherein the transmission is further provided with one or more valves for holding the forks of the pallet truck substantially in a horizontal plane.

30: The pallet truck as claimed in claim 28, wherein the transmission is connected to a reservoir for the purpose of realizing a closed hydraulic system.

31: The pallet truck as claimed in claim 28, wherein the lifting cylinder is provided with a flushing system, comprising:
(i) a spring and a ball placed in an opening of a piston of the lifting cylinder; and
(ii) a channel between a pressure side and a discharge channel of the piston which is closed in a retracted position of the cylinder and is opened in a fully extended position of the cylinder by moving the ball relative to the piston.

32: The pallet truck as claimed in claim 18, wherein the fork can be extended in the range of 800-1200 mm.
